(19) United States
(12) Patent Application Publication
(10) Pub. No.: US 2007/0196607 A1
(43) Pub. Date: Aug. 23, 2007

(54) ANTIMICROBIAL HOSE

(76) Inventor: Ivan W. Ong, Charlotte, NC (US)

Correspondence Address: CLIFF D. WESTON;MICROBAN PRODUCTS COMPANY, 1115 VANSTORY DRIVE, SUITE 125, HUNTERSVILLE, NC, 28078, US

(21) Appl. No.: 11/740,907

(22) Filed: Apr. 26, 2007

Related U.S. Application Data
(62) Division of application No. 10/658,030, filed on Sep. 9, 2003, now abandoned.

(51) Int. Cl. B32B 1/08

(52) U.S. Cl. 428/36.9

(57) ABSTRACT

A polyvinyl chloride based hose and a method of making such a hose is provided. The hose is characterized by an antimicrobial agent that is present in the interior of the hose that reduces or substantially eliminates the growth and proliferation of microbes.

### CROSS-REFERENCE TO RELATED APPLICATION

This application is a divisional of U.S. Ser. No. 10/658,030, filed on Sep. 9, 2003.

### FIELD OF THE INVENTION

The invention relates to tubing for conveying fluids and, more particularly, to hoses such as those that are primarily intended for outdoor use, such as in gardens.

### BACKGROUND OF THE INVENTION

The production of a hose, especially one made from polyvinyl chloride (PVC), is generally known in the art. Such hoses are used to convey several types of fluids. One more common application of such a hose is as a garden hose. The requirements of a garden hose are such that plasticizers, stabilizers, light screening agents, etc. are commonly added to the base PVC polymer to give the hose many desired properties such as flexibility, tensile strength, burst strength, abrasion resistance, cold-crack resistance, weather resistance, light stability, color permanence, etc. Even though many advances have been made with respect to a careful balance of the relative proportion and selection of such additive agents to the underlying PVC resin to obtain satisfactory hoses, several areas remain where such hoses can be improved.

One such area is bacterial contamination. Hoses, particularly garden hoses, convey water and absent extreme effort, a large quantity of moisture remains in a hose after use. If the hose is coiled for storage immediately after use, a considerable amount of water can be trapped inside the hose for a substantial period of time.

The long term exposure of a garden hose to stagnant moisture presents favorable growth conditions for various kinds of microbes including but not limited to bacteria, algae, mold, and fungi. The proliferation of such microbes can have a deleterious effect on the physical continuity of the hose and on plant and animal recipients of water from the hose.

Although people are often aware of the presence of bacteria and fungi in their hoses due to the “funny smell” of the water that first comes out of the hose, until recently the only corrective measure used for this problem was to simply let the water run through the hose for several minutes to wash out the hose before watering plants, watering animals, or spraying children at play on a hot summer day. The simple passage of water through the hose can do little to remove bacterial contamination, especially in instances where a considerable amount of biofilm has accumulated within the hose.

A potential solution for this bacterial problem would be to mix an antimicrobial agent into the polymer composition that is used to make the interior of the hose. For example, U.S. Pat. No. 5,091,442, issued Feb. 25, 1992, to Milner suggests that an antimicrobial agent, such as 2,4,4′-trichloro-2′-hydroxydiphenyl ether (commonly known as “triclosan”) may be mixed with a natural rubber latex plastisol to provide antimicrobial protection for a tubular article such as a condom or catheter. However, the effectiveness of the antimicrobial agent in the article will still diminish during use because the agent will gradually disappear from the surface of the natural rubber long before the latex wears down to expose the triclosan in the interior thereof.

The nature of natural rubber latex prevents the antimicrobial agent from migrating to the exposed surface of the latex from its interior. This limitation may be acceptable where the article makes a single contaminating contact and is then disposed of, but it is not acceptable in articles such as hoses that are long lived and repeatedly used in situations where there is plant, animal and human contact.

Milner '442 mentions that polyvinyl chloride may be used instead of the natural rubber latex, but the reference does not suggest how this is to be done. The method disclosed therein relates only to natural rubber latex, and the differences between latex and polyvinyl chloride preclude the application of the method discussed in Milner '442 to polyvinyl chloride.

Accordingly, there is a need for a solution to the growth of microbes in polyvinyl chloride hoses. The solution should reduce or substantially eliminate the proliferation of microbes within the interior of a hose. This solution should be economically efficient and mechanically efficient in that it should not price the resulting hose out of the market or compromise the structural integrity of the hose. This solution should also seamlessly integrate with existing hose manufacturing processes to reduce the engineering costs associated with the solution.

### SUMMARY OF THE INVENTION

The above problem of microbial growth in hoses is solved by the present invention which in one embodiment is a hose for transporting a fluid and which exhibits antimicrobial properties. The hose according to the invention comprises and inner tube made from a thermoplastic polymer composition. The thermoplastic polymer composition used to form the inner tube comprises polyvinyl chloride and an antimicrobial agent.

In a more specific embodiment, the invention encompasses a garden hose comprising an inner tube made from a thermoplastic polymer composition wherein the polymer composition comprises polyvinyl chloride and an antimicrobial agent selected from the group consisting of 2,4,4′-trichloro-2′hydroxy diphenol ether or 5-chloro-2 phenol (2,4-dichlorophenoxy).

In a further embodiment, the invention encompasses a method of making a hose for conveying fluids and which exhibits antimicrobial properties. The method according to the invention comprises the steps of: obtaining a thermoplastic polymer that comprises polyvinyl chloride, combining the thermoplastic polymer with a quantity of an antimicrobial agent selected from the group consisting of chlorinated phenols to create an antimicrobial thermoplastic polymer composition, forming an inner tube from said thermoplastic polymer composition, and providing an outer covering which surrounds the inner tube.

### DETAILED DESCRIPTION OF THE INVENTION

As used herein the term “antimicrobial” incorporates both a biostatic reduction in proliferation of microbial species, including but not limited to bacteria, algae, mold, and fungi, and a biocidal elimination of such microbial species.

One embodiment of the invention is a method of making a hose for conveying fluids and which exhibits antimicrobial properties. In very broad terms, the method according to the invention comprises the steps of obtaining a thermoplastic polymer wherein the thermoplastic polymer contains a quantity of polyvinyl chloride (PVC) then combining the thermoplastic polymer with a quantity of an antimicrobial agent selected from the group consisting of organic and metallic antimicrobial agents to create an antimicrobial thermoplastic polymer composition. The thermoplastic polymer composition is then formed into a tube. Preferably, the tube is then surrounded by a covering that can provide additional support and structure to the hose. Each of the above steps will be discussed in more detail below.

The preferred thermoplastic polymer for use in the invention is PVC or a polymeric composition that comprises PVC. PVC is often used in the industry as a very broad and general term that encompasses compositions that contain several other polymers in addition to polyvinyl chloride. For example, PVC is often used to describe mixtures of polyvinyl chloride and various additives such as monomeric plasticizers. Likewise PVC is sometimes used to identify tubing made from vinyl chloride-vinyl acetate copolymers or vinyl chloridevinylidene copolymers. As used herein the term PVC or polyvinyl chloride should be interpreted as including each of these polymer combinations and other such combinations commonly used in the hose making industry.

PVC is a very popular polymer for forming hoses of various kinds and has been used to make hoses since the 1930's. The underlying polymer technology for making PVC hoses is quite mature and well known to those skilled in the art. For example, most PVC hoses are multilayered structures. The innermost tubing is usually quite flexible because the PVC polymer composition contains various additives (e.g., plasticizers, stabilizers, etc.) that impart specific physical characteristics to the tubing.

The innermost tubing is then typically covered with another polymer composition comprising PVC and a different set of additives that impart a different set of characteristics (e.g., abrasion resistance, oil resistance, etc.). These outer coverings may or may not include fibrous components (e.g., nylon mesh, metal wires) that provide additional structural stability to the hose.

Those skilled in the art are well aware of the numerous combinations of polymers and layering architecture that may be used in making PVC hoses and may select the combination best suited to achieve a particular purpose. Examples of such diverse hose construction methods are discussed in, e.g., U.S. Pat. Nos. 2,645,249; 4,261,390; 6,526,859; WO85/03756 and WO 00/60297.

After the appropriate thermoplastic polymer composition has been chosen, it is combined with a quantity of an antimicrobial agent.

In preferred embodiments the antimicrobial agent is selected from the group consisting of organic antimicrobial agents and metallic antimicrobial agents. Suitable metallic antimicrobial agents include metallic ions such as silver and copper. Zeolites containing silver are a particularly preferred metallic antimicrobial agent.

The antimicrobial agent is preferably an organic antimicrobial agent that is compatible with PVC. The phrase compatible with PVC means that the antimicrobial agent does not compromise the structural integrity of the polymer to an unacceptable extent and that the PVC does not unacceptably interfere with the antimicrobial characteristics of the antimicrobial agent.

Organic antimicrobial agents are generally preferred due to their low cost and availability. Organic antimicrobial agents also have the benefit of generally seamless integration into existing hose manufacturing processes. A preferred class of organic antimicrobial agents for use in the practice of the invention is chlorinated phenols. Two particularly preferred chlorinated phenols that may be used in the practice of the invention are 2,4,4′-trichloro-2′-hydroxydiphenol ether (also known as triclosan) and 5-chloro-2 phenol (2,4-dichlorophenoxy) and mixtures thereof.

For ease of reference the method according to the invention will be discussed in the context of an extrusion process. As noted previously, however, the invention may be utilized in most, if not all, of the known methods for making PVC based hoses.

In accordance with the invention the inner tubing that forms the core of the hose may be made by combining a thermoplastic polymer, such as PVC, and a quantity of a plasticizer to promote flexibility of the hose. Other additives may be included as needed. As is known in the art, the inner tube may be prepared by conventional extruding techniques; that is, the raw materials are mixed, fused, granulated, charged into an extruder, and formed into a continuous tube by the simultaneous action of heat and pressure.

The precise temperatures and pressures utilized in the practice of the method may vary over the range of temperatures and pressures commonly employed in the manufacture of PVC hoses. Such temperatures and pressures vary in accordance with the components of the polymer compositions and the characteristics required of the end products. Typical extrusion processes, however, usually extrude PVC somewhere between 350° F. and 400° F.

The hot plastic mass is made homogeneous by the mechanical working action of the extruder screw and becomes semi-fluid because of its thermoplastic nature.

The antimicrobial agent may be added to the thermoplastic polymer in any of several ways. In one preferred embodiment the antimicrobial agent is added to the thermoplastic polymer either before or at the extruder. Alternatively, the antimicrobial agent may be added at some point in the extruder as long as sufficient time is provided for thorough mixing of the agent into the thermoplastic polymer.

Similarly, the antimicrobial agent may be added in different forms depending upon the particular manufacturing process utilized. The antimicrobial agent could be added as a technical grade additive or as a component of a carrier system.

In a particularly preferred embodiment the antimicrobial agent is triclosan that is added via a carrier system. The carrier system may be either a liquid or solid carrier system. One particularly preferred carrier system comprises triclosan contained in a liquid carrier system. The liquid carrier system is preferably the plasticizer that is utilized in the overall manufacturing process but can be any plasticizer that is compatible with the overall process.

Plasticizers from the phthalate family of plasticizers are well suited for use as a carrier in the practice of the invention. Diisodecyl phthalate (DIDP), diisononyl phthalate (DINP), dioctyl phthalate (DOP), and di(2-ethylhexyl)phthalate (DEHP) are particularly well suited for use with the invention. Epoxidized soybean oil (ESO) may also be used.

One liquid carrier that has shown particularly good results is the commercially available plasticizer that is sold by Velsicol Chemical Company under the trade name BENZOFLEX® 40B. BENZOFLEX® 40B is a universal low toxicity plasticizer that works well in PVC applications. Testing has shown that a BENZOFLEX® 40B/triclosan mixture having approximately 40% triclosan works well in PVC based hose extrusion processes and provides acceptable efficacy against microorganisms.

Alternatively, a solid carrier system may be used. In this embodiment the antimicrobial agent is pelletized in a composition that exhibits compatibility with the underlying thermoplastic polymer. Examples of solid carrier systems include thermoplastic elastomers. Such elastomers include, but are not limited to, ethylene vinyl acetate (EVA), ethylene methyl acrylates (EMA), ethylene butyl acrylates (EBA), and ethylene acrylic acid copolymers (EAA).

An example of such a solid carrier system is a masterbatch of an antimicrobial agent and an acrylate copolymer such as the ELVALOY® AC resins that are commercially available from DuPont. Testing has shown that a pelletized masterbatch of ELVALOY® having 10% triclosan works well in PVC based hose extrusion processes.

Other plasticizers commonly used in the manufacture of PVC piping may be used as well.

Preferably the amount of antimicrobial agent that is added to the thermoplastic polymer is sufficient to create an antimicrobial agent concentration of between about 200 ppm and 10,000 ppm, and more preferably between about 500 ppm and about 5000 ppm, based upon the weight of the resulting polymer composition. If the antimicrobial agent is added via a solid or liquid carrier, those skilled in the art will readily know how to adjust the feed rate of the antimicrobial agent/carrier mixture to achieve the above listed concentrations in the resulting tubing.

After the antimicrobial thermoplastic polymer composition has been formed into an inner tube of a hose, the inner tube may then be surrounded by one or more outer coverings. Such an outer covering may consist of a concentric layer of polymers having a different composition than the inner tube. In many instances, the outer covering incorporates a reinforcing material such as fibrous (e.g., nylon) meshes or wires or cords to provide extra stability and strength to the hose. The practice of the invention is not limited to a particular outer covering and may incorporate any type of covering known to those skilled in the art.

Finally, in a particularly preferred application of the method according to the invention, the method further comprises the step of adding connectors (e.g., male and female piping connectors or quick connectors) to either end of the hose to form a garden hose.

In yet a further embodiment the invention embodies a hose for transporting a fluid and which exhibits antimicrobial properties. The hose according to the invention comprises an inner tube made from a thermoplastic polymer composition that comprises polyvinyl chloride and an antimicrobial agent.

In preferred embodiments the antimicrobial agent is selected from the group consisting of organic antimicrobial agents and metallic antimicrobial agents. Suitable metallic antimicrobial agents include metallic ions such as silver and copper. Zeolites containing silver are a particularly preferred metallic antimicrobial agent.

Preferred organic antimicrobial agents include those commonly referred to as chlorinated phenols. 2,4,4′-trichloro-2′hydroxy diphenol ether (also known as triclosan) and 5-chloro-2 phenol (2,4-dichlorophenoxy) are two common chlorinated phenols that have been shown to work well in the practice of the invention. The invention also encompasses mixtures of these two agents.

In preferred embodiments the antimicrobial agent is present in the thermoplastic polymer composition in a concentration between about 200 ppm and 10,000 ppm, more preferably between about 500 ppm and 5,000 ppm, based upon the weight of the thermoplastic polymer composition.

As noted previously, the hose according to the invention is particularly well suited to form the inner tube of a multilayered hose such as a garden hose.

### EXAMPLES

Several samples of PVC based hose were made in accordance with the invention. In each instance a quantity of an ELVALOY® AC/triclosan mixture having approximately 10% triclosan was added to an extrusion grade PVC based polymer melt in an extruder. A sufficient quantity was added in three separate runs to make hose having three different concentrations of triclosan: 1000 ppm triclosan; 3000 ppm triclosan; and 5000 ppm triclosan; based upon the total weight of the resulting PVC polymer. A control sample having no triclosan was also prepared.

25 mm.×50 mm samples from each run were then tested in accordance with the Kirby Bauer test method using K. pneumoniae and S. aureus on Mueller-Hinton Agar. The results are shown in the following table.

TABLE 1

| Concentration of | K. pneumoniae, | S. aureus, |
|---|---|---|
| Antimicrobial Agent, | Zone of Inhibition, | Zone of Inhibition, |
| ppm | mm | mm |
| 0 | 0 | 0 |
| 1000 | 2 | 1 |
| 3000 | 6 | 1 |
| 5000 | 1 | 2 |

As the results show, the invention not only inhibited the growth of bacteria on the sample hosing but actually created zones of inhibition extending out from the samples (i.e., effectively inhibits bacterial coverage on and around the test samples).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of making a hose for conveying fluids and which exhibits antimicrobial properties, comprising:
obtaining a thermoplastic polymer wherein said polymer comprises polyvinyl chloride;
combining said thermoplastic polymer with a quantity of an antimicrobial agent selected from the group consisting of organic and inorganic antimicrobial agents to create an antimicrobial thermoplastic polymer composition;
forming an inner tube from said thermoplastic polymer composition; and
providing an outer covering which surrounds said inner tube.

14. A method according to claim 13 wherein said antimicrobial agent is organic.

15. A method according to claim 20 wherein the antimicrobial agent is selected from the group consisting of 2,4,4′-trichloro-2′-hydroxy diphenol ether or 5-chloro-2 phenol (2,4-dichlorophenoxy) and mixtures thereof.

16. A method according to claim 13 wherein the antimicrobial agent is metallic and comprises silver.

17. A method according to claim 15 wherein the concentration of the antimicrobial agent is between about 200 ppm and 10,000 ppm based upon the weight of the polymer composition.

18. A method according to claim 17 wherein concentration of the antimicrobial agent is between about 500 ppm and about 5000 ppm based upon the weight of the polymer composition.

19. (canceled)

20. A method according to claim 13 wherein said antimicrobial agent is selected from the group consisting of chlorinated phenols.
